(19) United States
(12) Patent Application Publication
(10) Pub. No.: US 2018/0080148 A1
(43) Pub. Date: Mar. 22, 2018

(54) ELECTROSPUN POLYMERIC POROUS FIBERS CONTAINING NANOMATERIALS

(71) Applicants: Paul K. Westerhoff, Scottsdale, AZ (US); Natalia Hoogesteijn von Reitzenstein, Phoenix, AZ (US); Shahnawaz Sinha, Chandler, AZ (US); Kiril D. Hristovski, Gilbert, AZ (US)

(72) Inventors: Paul K. Westerhoff, Scottsdale, AZ (US); Natalia Hoogesteijn von Reitzenstein, Phoenix, AZ (US); Shahnawaz Sinha, Chandler, AZ (US); Kiril D. Hristovski, Gilbert, AZ (US)

(21) Appl. No.: 15/705,645

(22) Filed: Sep. 15, 2017

Related U.S. Application Data
(60) Provisional application No. 62/395,467, filed on Sep. 16, 2016.

(51) Int. Cl. D01F 8/04; D01F 8/18; D01D 5/00; C02F 1/28; B01J 20/02; B01J 20/20; B01J 20/28; B01J 35/06; B01J 35/02; B01J 35/10; B01J 23/745; B01J 23/72; B01J 23/50; B01J 23/52; B01J 23/08; B01J 21/06; B01J 21/18

(52) U.S. Cl. CPC D01F 8/04; C02F 2305/08; D01D 5/003; C02F 1/288; C02F 1/281; C02F 1/283; B01J 20/0248; B01J 20/0211; B01J 20/0229; B01J 20/0233; B01J 20/0237; B01J 20/20; B01J 20/205; B01J 20/28023; B01J 35/06; B01J 35/023; B01J 35/1061; B01J 35/1066; B01J 20/28004; B01J 20/28083; B01J 20/28085; B01J 23/745; B01J 23/72; B01J 23/50; B01J 23/52; B01J 23/08; B01J 21/063; B01J 21/18; B01J 21/185; D01F 8/18

(57) ABSTRACT

Porous nanocomposite fibers are fabricated by electrospinning a solution including a polymer, a solvent, and a nanomaterial. The resulting fibers can be used in the form of a filter to remove a variety of organic and inorganic contaminants from an aqueous environment, and provide a macroscopic matrix to facilitate separation of the nanomaterial from the aqueous environment.

### CROSS-REFERENCE TO RELATED APPLICATION

This application claims the benefit of U.S. Provisional Application Ser. No. 62/395,467 entitled “ELECTROSPUN POLYMERIC POROUS FIBERS CONTAINING NANOPARTICLES” and filed on Sep. 16, 2016, which is incorporated herein by reference in its entirety.

### STATEMENT OF GOVERNMENT INTEREST

This invention was made with government support under 1449500 awarded by the National Science Foundation. The government has certain rights in the invention.

### TECHNICAL FIELD

This invention relates to electrospun polymeric porous fibers containing nanomaterials and methods of fabricating these polymeric porous fibers.

### BACKGROUND

Nanomaterials have been used as adsorbents for the removal of pollutants from water. However, using nanomaterials for water purification is difficult because the nanomaterials need to be separated from the aqueous matrix after use. Although nanomaterials may be incorporated into macroscopic materials that can be recovered from water, such as fibers or meshes, the macroscopic materials may inhibit contact of the water with the nanomaterials, thereby reducing effectiveness of the nanomaterials

### SUMMARY

In a first general aspect, fabricating nanocomposite fibers includes electrospinning a solution comprising a polymer, a solvent, and a nanomaterial to yield porous nanocomposite fibers.

In a second general aspect, a nanocomposite fiber includes a nanomaterial embedded in a porous polymer fiber.

In a third general aspect, a material includes the nanocomposite fiber of the second general aspect.

In a fourth general aspect, a material includes a plurality of nanocomposite fibers, each nanocomposite fiber including a nanomaterial embedded in a porous polymer fiber.

Implementations of the first through fourth general aspects may include one or more of the following features.

In some embodiments, the polymer is insoluble in water. Examples of suitable polymers include polystyrene, polyvinylpyrrolidone, polyvinyl alcohol, polyacrylonitrile, polyvinylidine fluoride, and polycaprolactone. A diameter of the nanocomposite fibers is typically in a range of 0.5 μm to 5 The nanocomposite fibers typically define pores having a pore size in a range of 25 nm to 200 nm. The nanomaterial may comprise 0.1 wt % to 10 wt % of the nanocomposite fiber. The nanomaterial may include at least one of a metal, a metal oxide, or a carbonaceous nanomaterial. Suitable metals include Ag, Cu, and Zn. Suitable metal oxides include TiO₂, In₂O₃, and Fe₂O₃. Suitable carbonaceous materials include graphene, graphene oxide, carbon nanotubes, and activated carbon. When the nanomaterial includes carbon nanotubes, the carbon nanotubes may be aligned longitudinally in the nanocomposite fiber.

The material of the fourth general aspect may be in the form of a mat, a mesh, a nonwoven material, or other arrangement suitable for water treatment.

The porous nanocomposite fibers and materials described herein can be used to remove contaminants from water, and can incorporate nanomaterials such as biocides, sorbents, and photocatalysts to impart a range of functionalities to the porous nanocomposite fibers.

### BRIEF DESCRIPTION OF THE DRAWINGS

FIG. 1 depicts electrospinning of fibrous mats integrated with nanomaterials.

FIG. 2 depicts formation of a Taylor cone and charged jet during the formation of polymer fibers.

FIGS. 3A-3C show transmission electron microscopy (TEM) images of TiO₂, In₂O₃, and Fe₂O₃ nanomaterials, respectively, utilized for fiber hybridization.

FIGS. 4A-4C show X-ray diffraction (XRD) spectra of TiO₂, In₂O₃, and Fe₂O₃ nanomaterials, respectively. In FIG. 4A, “A” indicates an anatase phase peak and “R” indicates a rutile phase peak.

FIGS. 5A and 5B show critical voltage to produce a Taylor cone in polystyrene (PS) solutions and polyvinylpyrrolidone (PVP) solutions.

FIG. 6 shows viscosity of PVP and PS solutions measured using a rheometer.

FIGS. 7A-7G show scanning electron microscopy (SEM) images of PS fibers with and without nanomaterials.

FIGS. 8A and 8B show SEM images of 1 wt % of In₂O₃ in PVP.

FIGS. 9A and 9B show SEM images of 5% TiO₂ in PS before and after electrospinning, respectively.

FIGS. 10A-10C show particle size distributions (n=500) for loose TiO₂ nanomaterials, 5 wt % TiO₂ nanomaterials in PS suspension prior to spinning, and 5 wt % TiO₂ nanomaterials in PS suspension after spinning, respectively.

FIGS. 11A and 11B show SEM images of 0.05 wt % Fe₂O₃ in PS and 0.5 wt % Fe₂O₃ in PS, respectively.

FIG. 12 shows a SEM image of a 5 wt % TiO₂, 1 wt % graphene platelet PS fiber bead.

FIG. 13 shows a SEM image of a 5 wt % graphene platelet PS fiber.

FIG. 14 shows SEM images of neat PS, C₆₀-PS, multiwall carbon nanotube-PS (MWCNT-PS), and graphene oxide-PS (GO-PS) networks, respectively, at 500×, 10,000×, and 20,000× magnification.

FIG. 15 depicts a process of forming porous fibers.

FIG. 16 shows pore diameter distribution of carbon nanomaterial (CNM) networks.

FIG. 17 shows differential pore volume as a function of pore width for neat PS, C₆₀-PS, MWCNT-PS, and GO-PS fibers.

FIG. 18 shows transmission electron microscope (TEM) images of neat PS and carbon nanomaterial PS composite fibers showing carbon nanomaterial additives inside fiber lengths.

FIG. 19 shows phenanthrene concentration over time for various carbon nanomaterial PS composites and nanomaterials.

FIG. 20 shows adsorption capacity for various carbon nanomaterial PS composites and nanomaterials.

### DETAILED DESCRIPTION

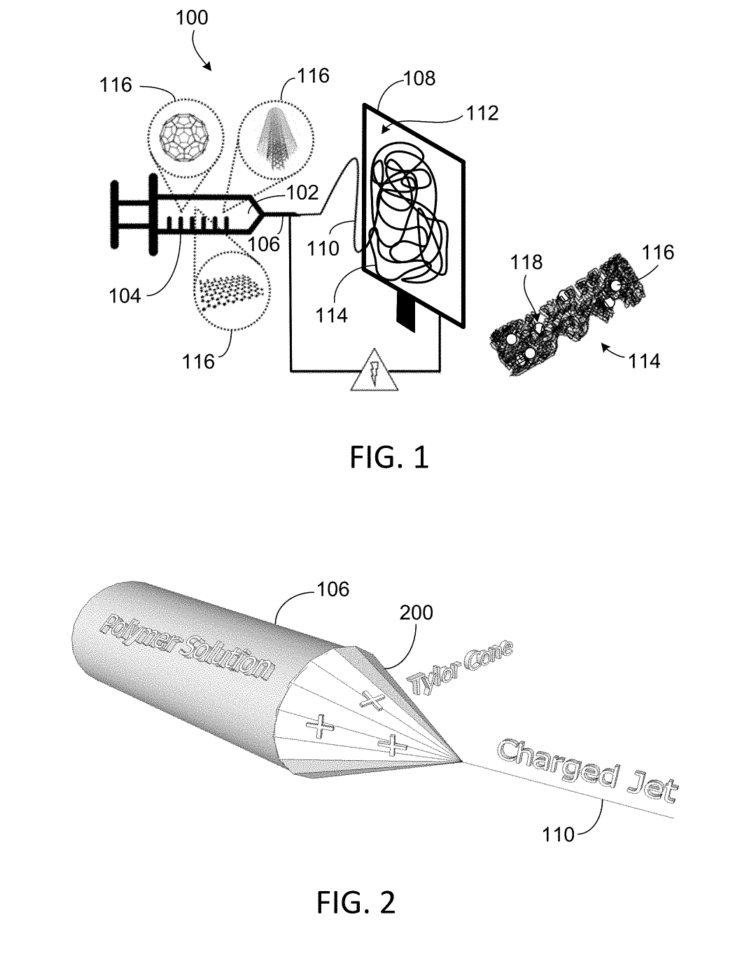

Electrospun polymer fibers with diameters in the nanometer to micron range have been used as reinforcements for composite materials, air and water filtration, soft tissue prostheses, wound dressing, cosmetics, protective clothing, and sensors. As depicted in FIG. 1, an exemplary electrospinning system 100 includes polymer solution 102 in syringe 104 having tip 106. Tip 106 may be a stainless steel needle connected to high voltage power supply (e.g., 5-40 kV). Polymer solution includes a polymer and a solvent. Polymer solution 102 flows to tip 106 at desired flow rate and can be controlled by a syringe pump. A high voltage potential is applied between tip 106 and grounded collector 108. The surface tension of polymer solution 102 is overcome by the strength of the electric field, forming a cone extending from tip 106, and a charged jet 110 of the polymer solution deposits onto grounded collector 108, forming matrix 112 of polymer fibers 114 having diameters in a range of nanometers to microns. FIG. 2 depicts tip 106 and charged jet 110 of the polymer solution extending from cone (“Taylor cone”) 200. Grounded collector 108 may be an aluminum foil coated collector placed about 10 cm away from tip 106. When polymer solution 102 includes nanomaterial 116, polymer fibers 114 include embedded nanomaterial. The inset shows polymer fiber 114 with nanomaterial 116 and defining pores 118.

Electrospraying functions similarly, utilizing a lower viscosity fluid and produces a fine spray instead of a charged jet. Nanomaterials can be incorporated into these polymer fibers either by adding them to the polymer solution before electrospinning, or as a post-electrospinning treatment applied to the spun polymer fiber. Electrospinning enables the addition of nanomaterials to a polymer solution directly, while concurrent electrospraying allows for increased dispersion of nanomaterials along the fiber surface. Electrospinning and electrospraying maintain polymer integrity through the adhesion of the wet spray onto a fiber matrix.

As described herein, electrospinning is used to immobilize nanomaterials in a flexible polymer. Integration of the nanomaterials makes the polymer fiber effective in removing a wide range of dissolved pollutants from water. There are several ways nanomaterials may be integrated into the polymer fibers. In one example, nanomaterials are blended with the polymer solution prior to the electrospinning process. In another example, nanomaterials are added after completion of the electrospinning process. Moreover, addition of nanomaterials provides various dimensionalities to the polymer fibers. These dimensionalities play a role in contaminant interactions and removal.

Addition of nanomaterials, including organic and inorganic nanomaterials, increases the mechanical stability and strength of the polymer fibers, and can also increase thermal stability of the polymer fibers, thereby improving performance and applicability of the polymer fibers. For example, the addition of inorganic nanomaterials, such as silver (Ag), copper (Cu), zinc (Zn), or a combination thereof to the polymer fiber, improves overall functionalities of these polymer fibers and also inhibits biological growth, thus minimizing biofouling and fiber clogging while purifying the water, and thus have wide applicability in water treatment. These nanomaterials on the fiber matrix dissolve and inactivate the microbes, thereby purifying the water. Likewise, integration of superfine ion-exchange (sIX) nanomaterials to the polymer fiber makes it more selective in removing selected inorganic contaminants from water, such as perchlorate, nitrate, and chromate. Likewise, integration of superfine powder activated carbon (sPAC) nanomaterials to the electrospun polymer fiber makes it selective for certain organic contaminants in water, such as polyaromatic hydrocarbons (PAH), for example phenanthrene (PNT), from water. Similarly, the addition of other nanomaterials, such as iron-oxide and titanium dioxide (photocatalysts), provides adsorbable and photocatalytic capabilities to the polymer fibers in removing both organic as well as inorganic contaminants and wide ranges of oxo-anions and heavy metals from the water. Therefore, careful selection and addition of these nanomaterials can make the electrospun polymer fibers effective in removing a variety of toxic organic contaminants (e.g., PAHs such as phenanthrene) and inorganic contaminants (e.g., arsenic, chromium, and nitrate) from water. Suitable dimensionalities along with the pore formations promote effectiveness of these polymer fibers for water treatment. In addition, integration of the nanomaterials in the polymer fiber promotes bonding of the nanomaterials to the polymer fiber structure, preventing or reducing release of nanomaterials to the environment.

In one embodiment, polymer solution 102 includes nanomaterials that sorb organic solvents in which raw polymer is dissolved, where the nanomaterials play the critical role in leading to pores in polymer fibers 114 after electrospinning. The inset in FIG. 1 depicts composite polymer fiber 114 with nanomaterials 116 and pores 118. Pores 118 create channels through which water and dissolved pollutants diffuse and react (sorb or transform) on the surface of nanomaterials 116 within the polymer fibers. Thus, porous polymer fibers can be produced by integrating various nanomaterials into polymer fibers through electrospinning processes, eliminating the need to post-treat the fibers with acids, solvents, heat, or other cost-intensive processes. The effectiveness of the resulting polymer fibers is based at least in part on dimensionality of the nanomaterials as well as pore formation.

Nanomaterials are defined as materials having at least one dimension in a range up to 100 nm. Nanomaterials can be designed from the bottom up (e.g., synthesized from gases or parent reactants), forming heterogeneous structures that are assemblies of nanoscale building blocks and the regions between those building blocks. This heterogeneous bundle structure on the nanoscale may distinguish these materials from other materials. Dimensionality and size of engineered nanomaterials influence their physical properties. Nanomaterials may be classified into elementary units based on structure: zero-dimensional (0D), one-dimensional (1D), two-dimensional (2D), and three-dimensional (3D) structures. Examples of zero-dimensional nanomaterials include quantum dots and hollow spheres. One-dimensional nanomaterials have an extended tubular shape, and include nanotubes, nanowires, and nanorods. Two-dimensional nanomaterials include nanowalls, nanosheets, and nanoplates. Three-dimensional nanomaterials include collections or crystals of lower-dimension nanomaterials which have been linked to form a larger network, such as zeolites.

Carbon nanomaterials may be used to tailor bottom-up nanoscale adsorbents for the efficient removal of pollutants from water. In some examples, C₆₀ fullerenes, multiwalled carbon nanotubes (MWCNT), and graphene oxide (GO) may be enmeshed into polystyrene (PS) fibers via electrospinning. Electrospinning carbon nanomaterials in a single step without post treatment coincides with pore formation as the solvent is volatilized from the carbon nanocomposite matrix. Sorption experiments with a representative polycyclic aromatic hydrocarbon, phenanthrene (PNT), shows similar adsorption capacity for neat polystyrene (PS, 2.8 mg/g), graphene oxide-PS (3.9 mg/g), MWCNT-PS (2.6 mg/g), and C₆₀-PS (1.6 mg/g).

Carbon nanomaterials have high surface area, tunable surface chemistry, porous bundle structure, and electronic properties that are well suited for water treatment. In addition, high surface area to volume ratio of carbon nanomaterials, coupled with tunable surface chemistry, can overcome limitations of traditional carbon bulk sorbents (e.g., granular and powdered activated carbons). Electrospinning and electrospraying methods can generate composite fibers with immobilized carbon nanomaterials of various shapes (e.g., 0D, 1D, and 2D carbon nanomaterials) with exposed surfaces that retain their sorptive functionalities. Thus, composite fibers described herein allow mass transport of aqueous phase pollutants to the surface of the incorporated carbon nanomaterials. As such, post-electrospinning treatment of the fibers is not needed to increase porosity of the polymer fibers.

To make an effective polymer fiber integrated with nanomaterials involves one or more steps. The electrospinning polymer solution is selected based at least in part on molecular weight and viscosity. Examples of suitable polymers include polystyrene (PS) and polyvinylpyrrolidone (PVP). The type of nanomaterial is also selected (e.g., silver, copper, zinc, iron oxide, titanium oxide, indium oxide, sIX, carbon, graphene, sPAC), along with loading rates for desired functionalities and overall distribution throughout the fibers. Parameters of the electrospinning process are also selected, such as the voltage applied in making the polymer fibers along with the distance maintained from injection to the grounded collector where fibers are deposited. Additionally, the humidity and temperature maintained in the electrospinning chamber, along with addition and feed rate of the nanomaterial-containing polymer solution can also impact the hierarchal structure and morphologies of these polymer fibers.

The nanomaterial addition to the polymers yields nanocomposite fibers with improved mechanical strength and resistance to wear as well as greater thermal stability than the polymers alone. Additionally, incorporated nanomaterials such as biocides, sorbents, and photocatalysts impart a range of functionalities to the polymer fibers. Industrial scale electrospinning equipment can be used to create non-woven nanocomposite fabrics and nanocomposite fibers for water purification.

Various type of nanomaterials (i.e., both organic and inorganic, including metal nanomaterials, metal oxide nanomaterials, cellulose nanomaterials, carbon nanotubes, quantum dots, graphene, graphene oxide, sPAC, and sIX) may be added to the polymer solution in making the polymer fibers. The nanomaterials may be combined with a suitable organic solvent, such as N, N-dimethylformamide (DMF), to form a mixture. The mixture may then be sonicated (e.g., in a sonicator bath) for a length of time (e.g., an hour). Sonication typically keeps the nanomaterials separated without causing agglomeration. Suitable polymers include, but are not limited to, polystyrene, polyvinylpyrrolidone, polyvinyl alcohol, polyacrylonitrile, polyvinylidine fluoride, and polycaprolactone. The polymer solution is typically stirred while heating for a length of time (e.g., heating at 50° C. with stirring for 24 hours). After stirring, the nanocomposite suspension may be mixed together and then used to fill a syringe. The syringe is placed in a syringe pump, and the pump is turned on. Once operation of the pump has been initiated, the high voltage power supply is increased (e.g., between 5-40 kV, depending on the viscosity and dielectric constant of the solution) to overcome the surface tension of the solution in the syringe, forming a Taylor cone as shown in FIG. 2, and a charged, continuous polymer jet exits the syringe and is collected on the collector a distance (e.g., 10 cm to 15 cm) away, as depicted in FIG. 1.

The Taylor cone formation during the electrospinning process indicates that the voltage applied will affect the surface tension of the polymer in forming a continuous polymer jet directed toward the collector. Voltage selection plays a role in forming a stable Taylor cone. A high voltage potential difference is applied to a charged polymer solution until the electrostatic forces of the voltage difference overcome the surface tension of the charged solution and a charged polymer jet is formed.

The composite nanocomposite fibers may be used to remove various types of contaminants from water that an ordinary polymer fiber without the nanomaterials would not be able to remove. In addition to removing what a typical polymer fiber may remove as fiber-mesh or mat as a filter, nanocomposite fibers may remove various types of dissolved organic and inorganic toxic compounds and heavy metals. The occurrence of pores on the polymer surface facilitates contact of the contaminants in the aqueous matrix with the nanomaterials.

The addition of low loadings of carbon nanomaterials such as graphene and carbon nanotubes to the polymer solution containing an organic solvent, such as DMF, coincides with a porous surface morphology, based at least in part on the high voltage and the interaction of organic solvents with the carbon nanomaterials. After drying, the carbon filler materials in the fibers sorb organic pollutants via the pores created on the polymer surface. Carbonaceous nanomaterials, such as multiwalled carbon nanotubes (MWCNT) are longitudinally aligned in the polymer due at least in part to the applied voltage in the electrospinning process. The use of non-water soluble polymers makes these fibers suitable for use in aqueous environments.

The electrospun polymer fibers integrated with nanomaterials with high porosity and surface area have wide application ranging from water treatment, air-purification, energy harvesting (as electrodes) and storage, catalysis, sensors, and many other applications. Addition of certain nanomaterials (e.g., copper, silver, and zinc) to the polymer fibers will deter biological growth. Integration of superfine ion-exchange (sIX) nanomaterials to the polymer fibers enhances selectivity for removal of well-targeted inorganic contaminants from water. In addition, integration of sPAC, MWCNT, or graphene nanomaterials in the polymer fiber enhances selectivity for removal of selected organic contaminants from water. The addition of other nanomaterials, such as iron-oxide or titanium dioxide (photocatalysts) provide adsorption capabilities to the polymer fibers for the removal of both organic as well as inorganic contaminants and wide ranges of oxo-anions and heavy metals from water. As such, the addition of nanomaterials allow polymer fibers to remove a various type of toxic organic and inorganic contaminants from water which would be unlikely without nanomaterial addition. With proper dimensionalities along with the pore formation, these polymer fibers are particularly effective for water treatment, and integration of nanomaterials with the polymer fiber binds the nanomaterials to the polymer fiber structure, preventing or reducing release to the environment.

Addition of nanomaterials also increases mechanical strength and thermal stability of polymer fibers. Addition of nanomaterials to electrospun polymer fibers, in terms of fiber diameters, morphology, and distribution may be controlled during the fabrication process. A high surface area, low volume, high functionalization with higher porosity, and ease of synthesis makes the electrospun fibers suitable for water treatment applications, including pretreatment for removing various types of contaminants prior to nanofiltration (NF) and as ion-exchange (IX) treatments. The addition of the graphene, MWCNT, sPAC, or a combination thereof to the polymer prior to electrospinning with other nanomaterials can create fibers with pores for advantageous contaminant interaction and removal. These composite fibers with the polymer and nanomaterials, provide a non-water soluble hybrid with nanocomposite fibers that may be utilized, for example, as non-woven textile material for pollution removal from water. The nanocomposite fibers may be utilized for the removal of various types of toxic contaminants from water.

Water treatment applications of nanocomposite fibers include use as fiber mats on cartridge filters or carbon-block filters. These filters are commonly used in household or industrial water treatment application. For carbon-block filters, an inert mesh is typically used to cover the carbon block. The filter mesh (i.e., covering) helps to maintain the carbon block integrity. This inert mesh may be replaced with a composite nanomaterial polymer fiber (e.g., including Ag, Cu, or Zn) to prevent biological growth on the filter surface, thereby reducing biological growth, biofouling, and fiber clogging while purifying the water.

Adding nanomaterials into polymer solutions before electrospinning creates unique hierarchical morphologies dispersed throughout small diameter nanocomposite fibers. Effects of polymer composition, nanomaterial type, loading, and electrospinning voltage conditions were studied. In one example, indium, iron, and titanium oxide engineered nanomaterials were dispersed into PVP or PS and electrospun. Nanomaterial loadings below 5 wt % did not affect critical voltage required for Taylor cone formation, whereas higher nanomaterial loadings typically require higher critical voltages. Polymer fiber thickness and macroscopic morphology was not noticeably impacted by up to 5 wt % nanomaterial loadings, and nanomaterial dispersion throughout the fibers were similar to their dispersion in initial polymer suspension. Nanomaterial loadings above 5 wt % increased viscosity of the polymer solution, resulting in a decreased fiber diameter.

Synergistic effects of physical parameters are factors in the structure and morphology of electrospun fibers. The electrospinning process is a balance of parameters including, but not limited to, conditions such as relative humidity, polymer weight, distance between capillary tip and collector plate, feed rate of solution, and solution composition. For example, adjusting the relative humidity in the environment affects the number, diameter, shape, and distribution of pores on the surface of electrospun fibers. Electrostatically, there is a balance between the induced charge on the polymer surface and the surface tension of that polymer. Surface tension is overcome by applying voltage. Viscosity dictates whether the polymer jet will break into droplets or travel as a continuous stream to the collector plate. High viscosity liquids tend to become jets, while low viscosity liquids tend to break up. By altering physical parameters and manipulating electrostatic forces, the fibers produced by electrospinning can have a variety of morphologies suited to different purposes. For example, fiber diameter may be manipulated via solution viscosity and applied voltage. Depending on the intended use of electrospun fiber mats (e.g., non-woven textiles), fiber diameter can be controlled. As described herein, fiber diameter is shown to vary based at least in part on nanomaterial addition. The addition of nanomaterial into solution adds another dimension to the process and its product.

The benefits of metal oxide nanomaterials are coupled with the process of electrospinning, affording several applications of economically produced, micron and nanometer-scale fibers. Electrospinning polymer fibers for water treatment applications generally requires use of non-water soluble polymers, thus the selected polymers can be soluble in non-aqueous solvents. Titanium dioxide (TiO₂) is an inexpensive and effective photocatalyst and chemical sensor in environmental remediation, photovoltaics, and optics.

The effect of nanomaterial addition on electrospun polymer fibers and the resulting changes in viscosity, critical voltage, and fiber morphology were investigated. Viscosity and critical voltage increased with increasing weight percentage of nanomaterials in the polymer solution. Critical voltage needed to produce a Taylor cone was higher for PS than for PVP. Fiber morphology was not directly affected by nanomaterial addition; instead the increase in viscosity and higher surface tension as a result of the 5 wt % nanomaterial concentration caused a roughly 50% decrease in diameter. While even distribution of nanomaterial was observed, sonication of polymer solutions can help prevent aggregation. The voltage changes needed to successfully spin higher weight percentages of nanocomposite composites can affect scale-up, including the power required to produce such fibers. Nanomaterial weight percentage was shown to affect the number of reactive sites available for nanomaterial functionality. Overall, TiO₂ and In₂O₃ nanomaterials can be successfully integrated into electrospun fibers with adjustments to voltage based on nanomaterial concentration in polymer solution. The potential for high surface area, low volume, functionalization capability, and ease of synthesis make electrospun fibers suitable for water treatment applications such as nanofiltration and ion exchange.

### EXAMPLES

Electrospun fibers with nanomaterials were prepared and, the effect of the nanomaterials on polymer properties, electrospinning conditions, and electrospun fiber morphology was evaluated. Specifically, differences in critical voltage needed to produce an unstable and stable Taylor cone by loading two polymer solutions with different nanomaterial weight percentages were measured. Voltage was slowly increased until a stable Taylor cone was observed. Solution viscosity was tested using rheometry. Metal oxide nanomaterials (TiO₂, indium oxide (In₂O₃), hematite (Fe₂O₃)) and electrospun polymer fibers were characterized using transmission electron microscopy (TEM) and energy dispersive X-ray analysis (EDX). TiO₂ was chosen because of its widespread use as a photocatalyst and arsenic absorbent, while In₂O₃ was chosen due to its use in semiconductor industries plus its visual color observation ability and high sensitivity of morphology using scanning electron microscopy (SEM) in order to observe nanomaterial distribution in the fibers. Fe₂O₃ was chosen because it is a good adsorbent of inorganic pollutants (such as arsenic) in drinking water.

Experimental Methods and Materials. PVP (K90, MW 360,000 g/mol, Fluka Analytical) and PS (MW 350,000 g/mol, Aldrich Chemistry) were used for electrospinning. These polymers were chosen based on their high molecular weights suitable for electrospinning. DMF (Sigma-Aldrich) was used as the organic solvent to dissolve both of the polymers.

Nanomaterials used for loading include indium oxide nanopowder from U.S. Research Nanomaterials, Inc. (Houston, Tex.) and Degussa AG Aeroxide P25 TiO₂ (Frankfurt am Main, Germany). Fe₂O₃ nanomaterials were synthesized by modifying a method described in Matijevié et al., Colloid Interface Sci. 1978, 63, 509-524, which is incorporated herein by reference. Briefly, anhydrous ferric acid (Sigma-Aldrich) was prepared over heat in a 4 mM HCl solution and 0.25 M FeCl₃ stock. The solution was then placed in a laboratory oven (HP 5890 series II) at 100° C. and incubated for 10 hours. The Fe₂O₃ nanomaterials were centrifuged and washed five times with nanopure water. After rinsing, the Fe₂O₃ nanomaterials were stored at 4° C.

In₂O₃-polymer composite, TiO₂-polymer composite, and Fe₂O₃-polymer composite solutions were prepared by dispersing various nanomaterial concentrations (0, 0.05, 0.5, and 5 wt %) in DMF by one hour of bath sonication (Branson 2510, Branson Ultrasonic, Dansbury, Conn., USA). Nanomaterial weight percentage loadings (0.05-5 wt %) into the polymers were chosen to span multiple orders of magnitude. Polymer (20 wt % of either PS or PVP) was added to the solution and gently stirred for 24 hours at 40° C.

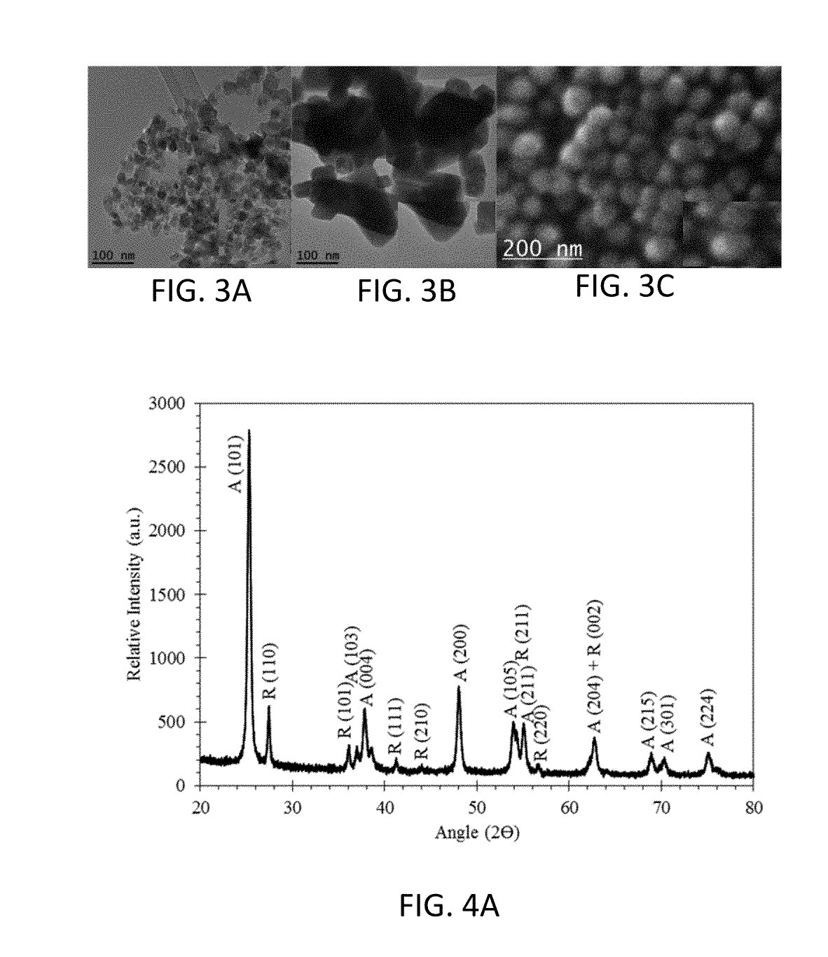

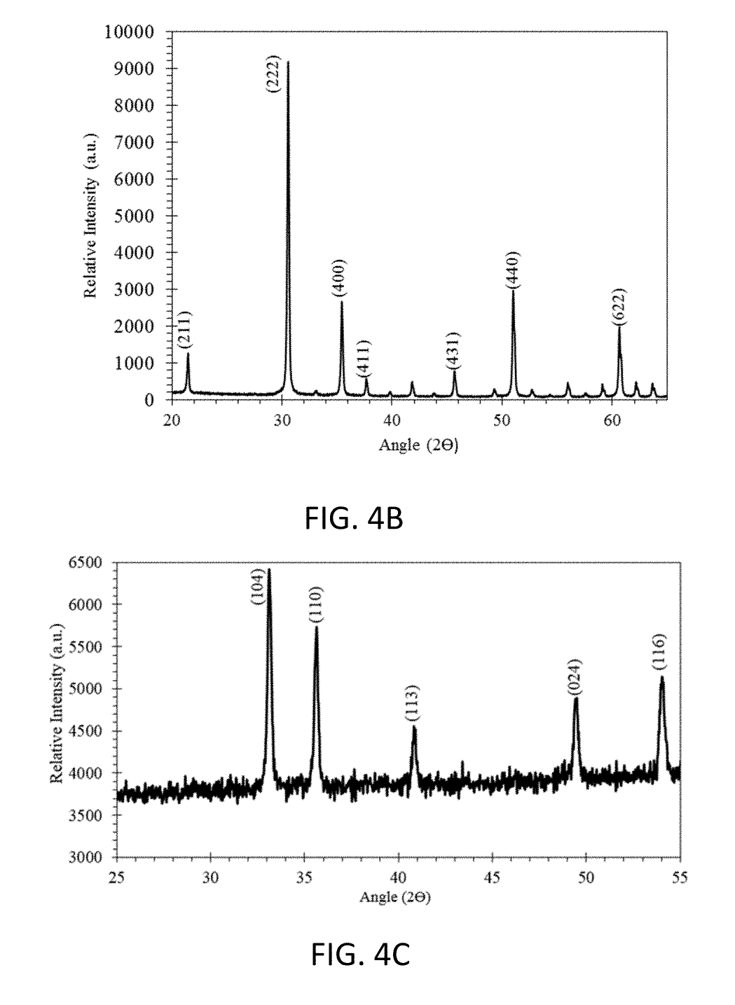

TiO₂, In₂O₃, and Fe₂O₃ nanomaterials were analyzed using transmission electron microscopy (TEM) and X-ray Diffraction (XRD). FIGS. 3A-3C show TEM images of TiO₂, In₂O₃, and Fe₂O₃ nanomaterials, respectively. FIGS. 4A-4C show XRD spectra of the TiO₂, In₂O₃, and Fe₂O₃ nanomaterials, respectively. 500 particles of each material were counted by hand using ImageJ as described in Schindelin et al., Nat. Methods 2012, 9, 676-682, which is incorporated herein by reference. TiO₂ nanomaterials averaged 27±7 nm in size, In₂O₃ nanomaterial averaged 80±17 nm, and Fe₂O₃ averaged 46±3 nm. The background noise in FIG. 4C is due to fluorescence. The XRD reflections of In₂O₃ nanomaterials are characteristic of phase-pure nanocuboids. TiO₂ was mostly anatase. Fe₂O₃ crystalline phase identification was confirmed by comparing XRD reflections with the pattern of the Joint Committee on Powder Diffraction Standards database.

An apparatus similar to electrospinning systems known in the art was constructed. Briefly, electrospinning was performed using a high voltage power supply that provided up to 40 kV (Gamma High Voltage, Ormond Beach, Fla.), a syringe pump (New Era NE-300, Farmingdale, N.Y.), a 10 mL plastic syringe, and a grounded aluminum foil coated collector that was placed 15 cm away from the syringe tip. The experimental procedure involved loading the solution into a plastic 10 mL syringe fitted with a stainless steel needle that was connected to the high voltage power supply. The nanocomposite composite solution was injected at 20 μL/hour through a stainless steel, 22-gauge needle (Sigma-Aldrich stainless steel 304 syringe needle) with an alligator clip attached to charge the needle and the polymer solution as it exited the capillary tip. The entire system was enclosed to mitigate the effects of air currents on the system and for safety. Humidity was measured using a Xikar hygrometer and was maintained at 40% at 75° F. using a sponge saturated with deionized water inside the electrospinning enclosure. All experiments were run grouped by metal oxide on the same day in quick succession to maintain similar ambient experimental conditions.

Nanomaterials were characterized using a Philips CM200-FEG transmission electron microscope and a Siemens D5000 powder X-ray diffractometer. SEM images of fibers were obtained using a JEOL 2010F. Viscosity of polymer solutions was measured using a TA Instruments AR-G2 rheometer. Fiber diameters were measured using ImageJ software (National Institutes of Health, Washington, D.C., USA).

Results. Taylor cone formation indicates that the voltage applied affects the surface tension of the solution and is a precursor to a stable, continuous polymer jet. The charged jet is a distinguishing characteristic between electrospinning and electrospraying, where the end result of electrospraying is charged polymer droplets without fiber formation. The critical voltage occurs when the jet forms. Droplet shape at the tip varies with applied voltage. At lower voltages, the originating drop at the capillary tip is larger than the diameter of the capillary tip. As voltage increases, the jet originates first from the bottom of the drop, and then the drop diameter decreases with increasing voltage until the jet emerges from the solution within the syringe tip.

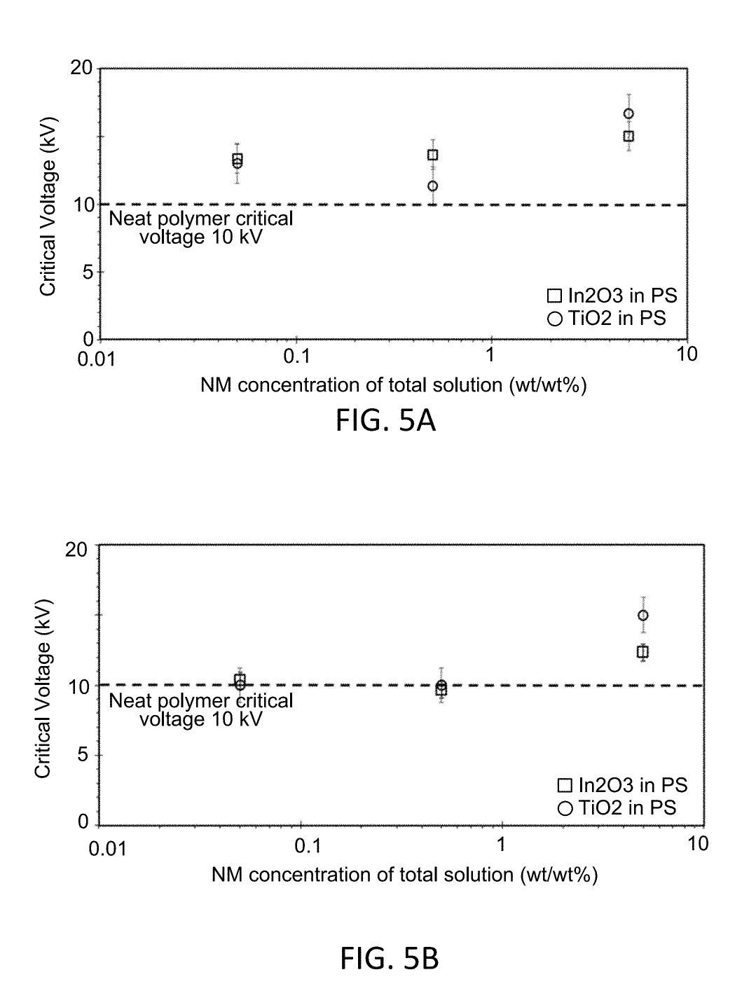

FIG. 5A shows critical voltages for In₂O₃ and TiO₂ nanomaterials at different loadings (NM concentration) in PS. FIG. 5B shows a companion plot using PVP. Error bars indicate one standard deviation from triplicate experiments using the same nanocomposite solution. For both polymers, the critical voltage did not vary for nanomaterial loadings lower than 0.5 weight percentage of nanomaterial per unit polymer (wt %). The critical voltage needed to produce a Taylor cone without nanomaterial in solution was 10 kV. The critical voltage needed to form a stable Taylor cone increased (p<0.05, Student's t-test) by roughly 25% when adding up to 5 wt % TiO₂ and In₂O₃ in PS or PVP. The increase in voltage needed to form a Taylor cone may be attributed to increasing viscosity caused by nanomaterial addition. There was not a statistical difference (p<0.05) between 0.05 wt % and 0.5 wt % nanomaterial to increase critical voltage or polymer solution viscosity. Similar variability has been seen for small weight percentages (0-10 wt % nanomaterials) in linear PS chains.

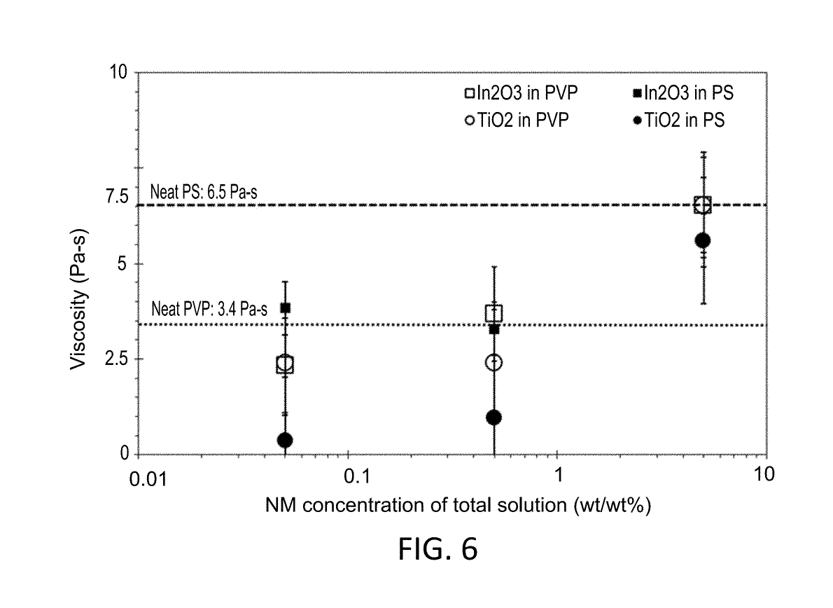

Solution viscosity can influence the voltage needed to successfully produce a polymer jet in electrospinning and also affect fiber diameter, droplet shape, and jet trajectory. Viscosity of PVP and PS solutions were measured using a rheometer, and results are shown in FIG. 6. Error bars indicate one standard deviation. Viscosity stayed constant through 0.5 wt % nanomaterial loading, and increased at 5 wt % nanomaterial loading. Addition of nanomaterials to polymer solutions is known to affect solution behavior unexpectedly; nanomaterial addition can reduce viscosity instead of increase it, as predicted by the Einstein-Batchelor law for spherical-particle suspensions. As shown in FIG. 6, viscosity increased (p<0.05, Student's t-test) with higher mass fraction of nanomaterials. Increasing solution viscosity requires increased voltage to produce a Taylor cone and a charged jet. According to the Einstein-Batchelor law for spherical particle suspensions, adding particles should increase the viscosity of their host polymer. However, this is not the case for all nanomaterial loadings. Polymer nanocomposites display a variety of unexpected behavior, most notably a reduction in viscosity. Reduced viscosity has been observed in PS solutions containing dispersed fullerene and magnetite nanomaterials. This phenomenon has been attributed to a decrease in excluded volume due to a change in polymer conformation; the viscosity of polymer melts do not follow convention when nanomaterials are introduced.

Changes in viscosity are known to affect morphology of electrospun fibers. For example, beading in polymer fibers refers to segments of polymer that are thicker than adjacent elongated fiber. Beading is usually round in nature, much like pearls on a necklace, as described herein with respect to FIG. 8A. Beads are understood to form in electrospun fibers due to the competition between capillary forces and electrical stress.

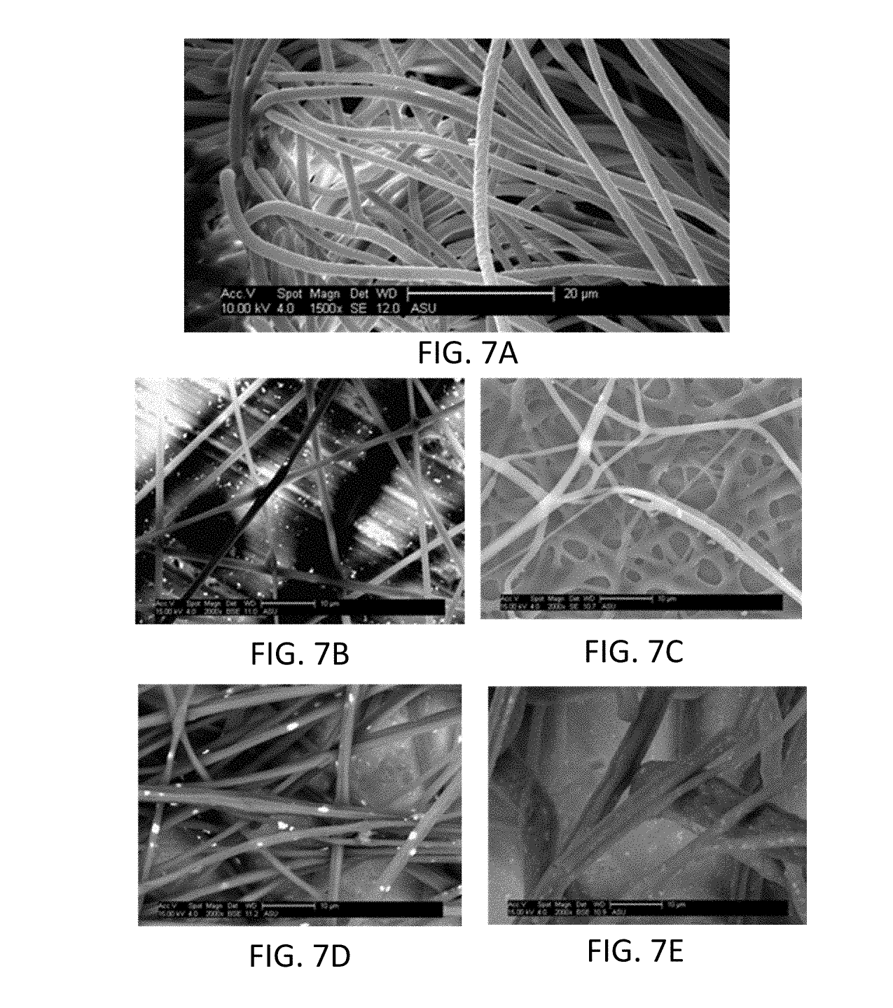

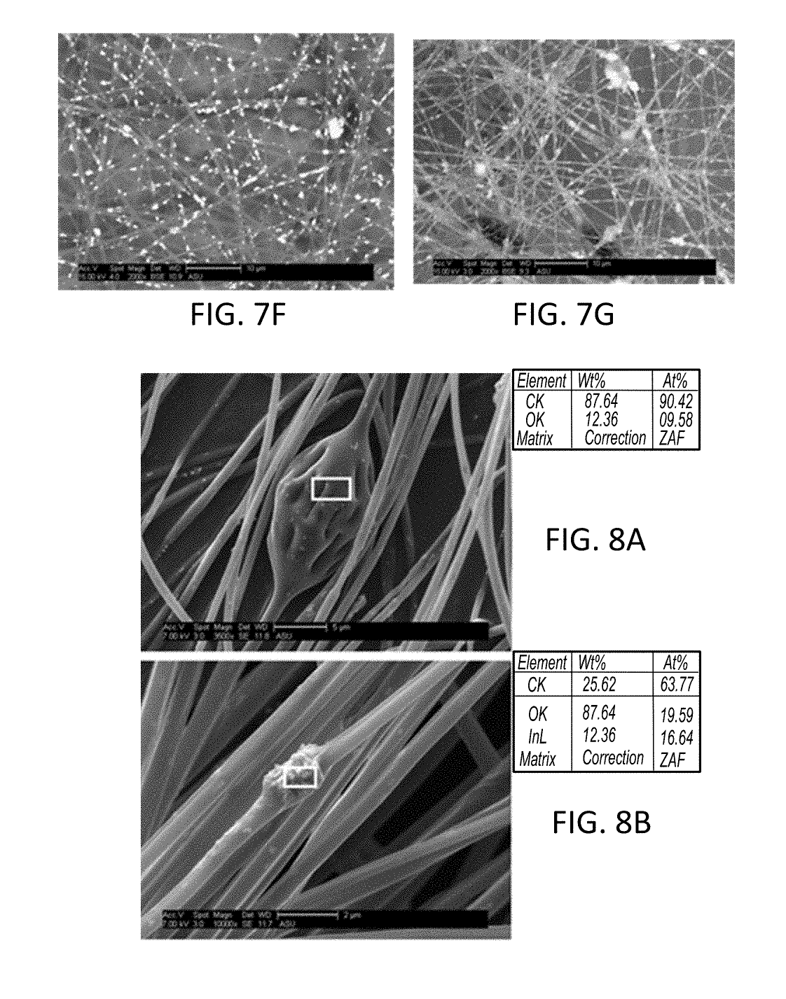

Fibers spun without added nanomaterials are smooth fibers, with constant diameter thickness, and show no beading as shown in FIG. 7A, a SEM image of electrospun PS fibers with no added nanomaterials. Polymer molecular weight and solution concentration have been linked to beading and branching in electrospun fibers by causing increases in solution viscosity and surface tension. FIGS. 7B, 7D, and 7F show SEM images of PS fibers with 0.05 wt %, 0.5 wt %, and 5 wt % In₂O₃ nanomaterials. FIGS. 7C, 7E, and 7G show SEM images of PS fibers with 0.05 wt %, 0.5 wt %, and 5 wt % TiO₂ nanomaterials. As seen in FIGS. 7B-7G, nanomaterial addition increases beading and branching: fiber morphologies with 0.05 wt %, 0.5 wt %, and 5 wt % mass fractions of In₂O₃ and TiO₂ are not continuous fibers like those spun without nanomaterials. Backscatter mode shows that nanomaterials are evenly distributed in the PS fibers. These morphology changes reflect the changes in solution composition. Typically, increases in solution viscosity will cause increases in beading and other defects in electrospun fibers.

With nanomaterial addition, fiber diameter remained constant between 1 and 3 μm. Data in Table 1 shows the effect of nanomaterial loading and polymer on electrospun fiber diameter. Average fiber diameter is given to one standard deviation. Measurements were made in triplicate. PVP solutions showed no effect with 0.05 wt % nanomaterial addition, and then a reduction in half of fiber diameter by addition of 0.5 wt % and 5 wt % nanomaterial. PS with no nanomaterial addition had a lower fiber diameter, which is consistent with the higher viscosity of PS. Adding 0.05 wt % nanomaterial significantly increased fiber diameter, but was unchanged at highest nanomaterial loading of 5 wt %.

TABLE 1
Effect of nanomaterial (NM) loading and polymer on electrospun fiber diameter.

| | Fiber Diameter (μm ± 1 SD) | | | |
|---|---|---|---|---|
| Sample | No NM | 0.05 wt % NM | 0.5 wt % NM | 5 wt % NM |
| In₂O₃ in PVP | 1.6 ± 0.25 | 1.93 ± 0.53 | 0.59 ± 0.15 | 0.81 ± 0.23 |
| TiO₂ in PVP | 1.6 ± 0.25 | 1.75 ± 0.41 | 0.68 ± 0.20 | 0.83 ± 0.35 |
| In₂O₃ in PS | 0.81 ± 0.20 | 1.9 ± 0.43 | 1.8 ± 0.52 | 0.82 ± 0.20 |
| TiO₂ in PS | 0.81 ± 0.20 | 1.45 ± 0.53 | 3.8 ± 1.8 | 0.72 ± 0.48 |

PVP solutions with no nanomaterial had a diameter of 1.6 μm, increasing by a few microns with the addition of 0.05 wt % nanomaterial, then decreasing by roughly half with the addition of 0.5 wt % and 5 wt % nanomaterial. For PS, fiber diameter was 0.8 μm without any nanomaterial, which is consistent with the higher viscosity of PS. The PS fiber diameters double with the addition of 0.05 wt % and 0.5 wt % nanomaterial. However, with the addition of 5 wt % nanomaterial, diameter decreased in size by roughly half (p<0.05, Student's t-test). Based upon what is known about spinning solutions with higher viscosity and surface tension, a variation in fiber diameter of polymer solutions containing nanomaterial is believed to be caused by the increased viscosity of the polymer jet caused by nanomaterial addition.

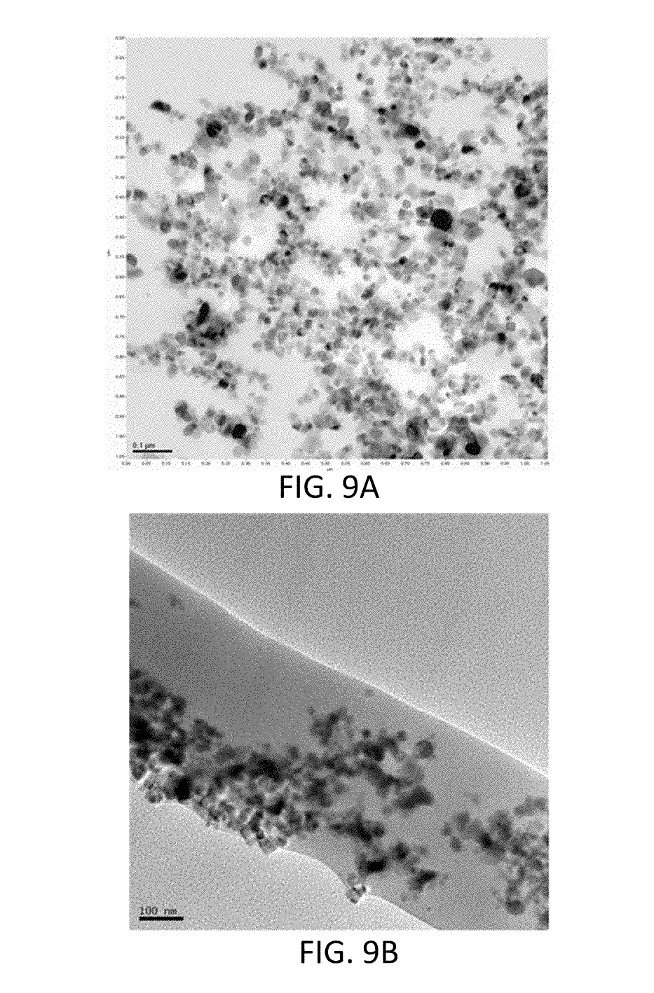

Beading is common in electrospun fibers. FIGS. 8A-8B show SEM mages of 1 wt % In₂O₃ in PVP. FIG. 8A shows a polymer bead with In₂O₃ nanomaterial in it, and FIG. 8B shows an aggregate of In₂O₃ nanomaterial. FIGS. 9A and 9B show SEM images of 5% TiO₂ in PS before and after electrospinning, respectively. The free length (L_{f}) of the suspension as described in Khare et al., Polymer (Guildfi 2010, 51, 719-729, which is incorporated herein by reference, was found to be 161±16 nm before spinning and 155±6 nm after spinning. The state of dispersion of the TiO₂ suspensions in polystyrene was similar before and after spinning.

L_{f} is described as the characteristic size of unreinforced polymer domains within nanomaterial suspensions. By quantifying the size of these unreinforced particle domains, dispersion states can be distinguished between polymer suspensions. L_{f} is reduced as a product of more uniform dispersion, decreasing particle size, and increased nanomaterial loading. The L_{f} of a 5% TiO₂ suspension before and after spinning was found using the TEM images shown in FIGS. 9A and 9B in accordance with the method described in Khare et al. The L_{f} of 5% TiO₂ in PS before spinning was 161±16 nm, while that of 5% TiO₂ in PS after spinning was 155±6 nm. Changes in the state of dispersion of nanomaterials can influence electrospinning performance; in this case, the state of dispersion of the TiO₂ suspensions in polystyrene was similar before and after spinning despite the method of data interpretation.

The distribution of nanomaterials in fibers becomes important for certain applications, for example, when nanomaterials in fiber function as reactive sites for sorbents. In order for nanocomposite electrospun fibers to be useful, nanomaterials must be readily accessible. Nanomaterial distribution in fibers is seen in FIGS. 7B-7G, 8A-8B, and 9A-9B. The 5 wt % nanocomposite solutions shown in FIGS. 7F and 7G show a desirable distribution of nanomaterial. Nanomaterial aggregates were counted manually inside 10 μm² areas using TEM images like those found in FIGS. 7B-7G (n=500 aggregates). The 5 wt % In₂O₃ shows the most uniform distribution, with an average of 6±2 nanomaterial cluster/10 μm² area, versus 4±1 cluster/10 μm² area for 5 wt % TiO₂. EDX analysis shown in FIGS. 8A and 8B confirmed indium and titanium presence in electrospun fibers observed utilizing backscatter SEM imaging. FIGS. 8A and 8B also show magnified images of PVP fibers with 1 wt % In₂O₃ added, which formed both polymer beads and aggregated In₂O₃ beads. Nanomaterial aggregations may occur due to polymer-nanomaterial interactions, as well as electrostatic forces between the nanomaterials themselves.

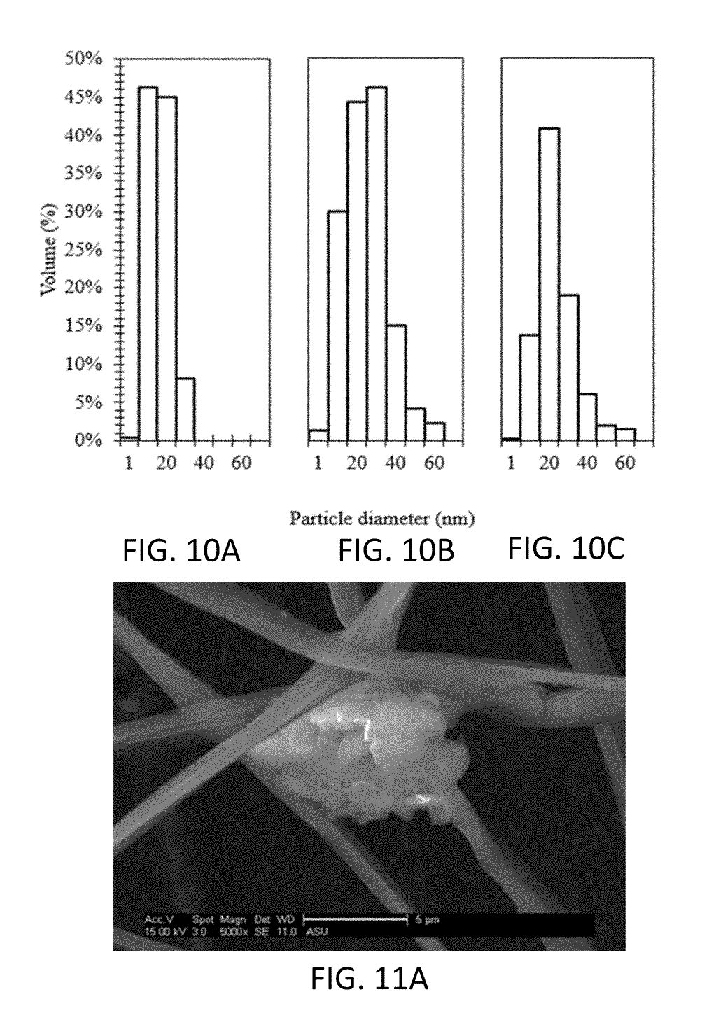

In addition to assessing the state of dispersion of 5% TiO₂ in PS, the particle size distributions of this suspension were evaluated. Particles were manually counted and measured using ImageJ (n=500 particles). FIGS. 10A-10C shows particle size distributions (n=500) for loose TiO₂ nanomaterials, 5% TiO₂ in PS prior to spinning, and 5% TiO₂ in PS after spinning, respectively. As seen from the three distributions, the majority of the nanomaterials were in the 10-20 nm range in size and could not exert effects on nanomaterial dispersion or electrospinning performance by changing diameter. Coupled with the uniformity of state of dispersion throughout the experiment, these results indicate little to no influence on electrospinning performance by interactions of nanomaterials with the polymer matrix or within the nanomaterial aggregates. The nanomaterials formed aggregates as soon as they were suspended, despite sonication, and maintained their state through the experiment.

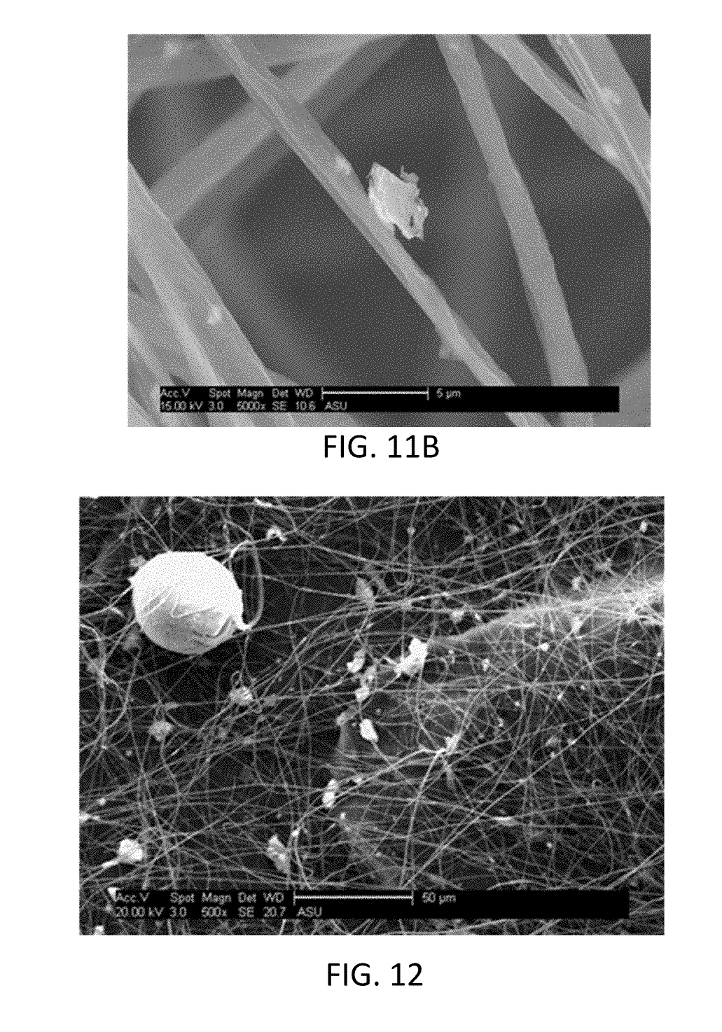

FIGS. 11A and 11B show SEM images of 0.05 wt % and 0.5 wt % Fe₂O₃ in PS, respectively. Fe₂O₃ nanomaterials were added to PS solution for comparison against TiO₂ and In₂O₃. Electrospinning is based on the manipulation of charge. Nanoscale Fe₂O₃ is highly conductive, displays behavior unique to nanomaterials, and may behave differently in the electrospinning system. Similar with TiO₂ and In₂O₃, the Fe₂O₃ nanomaterials are discernible at 0.5 wt % in the fiber, and are well distributed through the polymer filament.

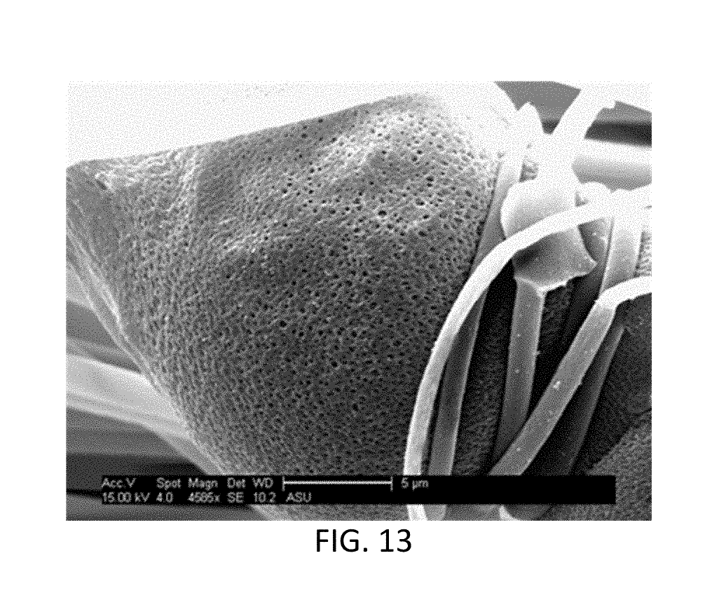

Nanocomposite fibers made in a single step, without post-treatment (e.g., attachment of nanomaterial after spinning a polymer fiber, calcination of a non-polymeric metal sol) as described herein confirmed their use as active sites for remediation purposes, such as adsorption. A single-point arsenate (As(V)) adsorption experiment was conducted using a nanocomposite fiber created from a dispersion of 5 wt % TiO₂ in PS and DMF. With the incorporation of TiO₂ in the fiber, sorption of As(V) was expected; however, upon experimentation, no As(V) sorbed onto the composite fiber. It is believed that, while TiO₂ is well dispersed in the polymer fiber, the fiber was smooth and all measurements indicated that it was non-porous. A hybrid nanocomposite fiber was spun by dispersing both TiO₂ and graphene together in PS and DMF. FIG. 12 shows a SEM image of a 5 wt % TiO₂-1 wt % graphene platelet PS fiber bead. However, these porous fibers did not adsorb As(V). To prove the porosity could allow sorption of pollutants by nanomaterials within the polymer fiber adsorption, experiments using a non-polar organic pollutant (phenanthrene (C₁₄H₁₀)) confirmed >50 times more adsorption on the hybrid fiber than a polymer-only (control) fiber (no nanomaterial). The phenanthrene sorption, on a mass removal basis (mg phenanthrene per g graphene) is equivalent between a dispersion of graphene in water (no fiber) and the hybrid nanocomposite fiber, thus indicating that the organic pollutant adsorbs only to the graphene and that the graphene nanomaterial surface is available within the pores of the fiber for phenanthrene. The lack of As(V) sorption in the hybrid TiO₂/graphene-polymer fiber is thought to be due to the positioning of the TiO₂ nanomaterial within the fiber rather than lack of pore formation. However, the creation of pores that allow connectivity between As(V) in water and TiO₂ may be realized with TiO₂-graphene nanomaterials. FIG. 13 shows a SEM image of a 5 wt % graphene platelet PS fiber. Pores are clearly visible. Graphene composite fibers have shown a 225 mg/g adsorption capacity for phenanthrene.

Superfine powdered activated carbon (sPAC average size 200 nm) was added at low loading to polystyrene (PS) to produce an adsorbent fiber that was tested for removal of phenanthrene (PNT) using batch adsorption experiments. Average pore size on sPAC-PS fibers was 112±23 nm. The Hybrid sPAC-PS fibers (specific surface area 43 m²/g), however, showed an adsorption capacity (Freundlich K) of 0.96 mg PNT/g sPAC-PS, compared to an adsorption capacity of 1.05 mg PNT/g sPAC and 0.15 mg PNT/g PS.

Preparation of electrospinning suspension. Polystyrene (PS, MW 350,000 g/mol, Sigma-Aldrich, St. Louis, Mo.) was selected for electrospinning because of its high hydrophobicity and mechanical integrity. DMF (Sigma-Aldrich, St. Louis, Mo.) was used as the organic solvent for dissolution of PS prior to electrospinning. Nanomaterials tested in this study include graphene oxide platelets (N002-PDE, Angstron Materials, Dayton, Ohio, Oxygen content: 10-30%, Carbon content: 60-80%, specific surface area 400 m²/g), multi-walled carbon nanotubes (OH functionalized MWCNT 10-20 nm, Cheap Tubes, Grafton, Vt., Specific Surface Area 100 m²/g), and C₆₀ fullerenes (Fullerene C₆₀, catalog number MR6LP, 99+%, MER Materials, Tucson, Ariz.). All carbon nanomaterials-PS composites were produced by mixing 1% (m/v) nanomaterial with DMF, and the solution was then sonicated with a probe (Misonix, N.Y.) for 15 minutes using the CEINT/NIST Preparation of Nanomaterial Dispersions from Powdered Material Using Ultrasonic Disruption. 20% (m/v) PS was then added to the DMF-nanomaterial suspension. The final suspension was stirred over heat (40° C.) for 12 hours.

Electrospinning set-up and parameters. Electrospinning was performed using a high voltage power supply that provided up to 40 kV (Gamma High Voltage, Ormond Beach, Fla.), a syringe pump (New Era NE-300, Farmingdale, N.Y.), a 10 mL plastic syringe, and a grounded aluminum foil collector that was placed 15 cm away from the syringe tip. The experimental procedure consisted of loading the solution into the syringe fitted with a stainless steel needle that was connected to the high voltage power supply. The nanomaterial-PS composite solution was injected at 1 mL/h through a stainless steel, 22-gauge needle (Stainless Steel 304 syringe needle, Sigma Aldrich, St. Louis, Mo.) with an alligator clip attached to charge the needle and the polymer solution as it exited the capillary tip. The entire system was enclosed to mitigate the effects of air currents on the system and for safety. Humidity was measured using a Xikar hygrometer and was maintained at 40% at 75° F. using a sponge saturated with deionized water inside the electrospinning enclosure.

Fiber characterization. Fibers were imaged using a Philips CM12 transmission electron microscope (TEM), and scanning electron microscope (SEM) images of fibers were obtained using a JEOL 2010F. Fiber pore diameter (n-500) and surface pore diameter (n-100) measurements were taken using ImageJ software (National Institutes of Health, Washington, D.C., USA). Brunauer-Emmett-Teller (BET) surface areas using N2 adsorption-desorption isotherms for C60, MWCNT, GO, and neat PS fibers were analyzed using a Micrometrics TriStar II 3020 surface area analyzer. Wettability was determined via water contact angle measurements run in triplicate on an Attension Theta contact angle meter (Biolin Scientific, Stockholm, Sweden) in conjunction with OneAttension software. Adsorption capacity was tested using PNT as a model pollutant.

Phenanthrene Adsorption Experiments Under Pseudo-Equilibrium Conditions. All phenanthrene (PNT) adsorption experiments were conducted in ultrapure water (Barnstead™ GenPure™, ThermoFisher Scientific, Waltham, Mass.) in completely mixed batch reactors. Briefly, 0.02 grams of carbon nanomaterial-PS fibers or 0.0002 grams of loose carbon nanomaterial was placed in empty 40 mL glass bottles capped with Teflon-lined septa caps. Later vials were filled with distilled and deionized water, and spiked with predetermined amounts of concentrated PNT stock solution. The concentrated stock solution of PNT (i.e., 1000 mg/L) was prepared in methanol. The ratio of methanol to water was kept below 0.1% (v/v) to eliminate any co-solvent effects on adsorption. After spiking, additional Ultrapure water was added to eliminate headspace in the reactors, which were then placed sideways on a shaker table at 200 rpm for up to six days with samples measured at time points: 0.5, 1, 3, 6, 24, 72, and 144 hours. pH was measured but not manipulated in order to replicate ambient environmental conditions (pH=6.5-8.1). After removing the reactors from the shaker table, supernatants were filtered using Whatman GF/F 0.7 μm filters. Aqueous PNT concentrations were measured spectrophotometrically at λ=250 nm using UV-Visible spectroscopy (Hach DR2000, Hach USA, Loveland, Colo.). A broader spectrum (λ=200-800 nm) was analyzed to ensure there was no unexpected interferences from dissolution of PS and loose carbon nanomaterials. The amount of PNT adsorbed onto an adsorbent at time t, qt, was calculated using Equation 1:

$${q}_{t} ( \frac{mg}{g} ) = \frac{( {C}_{0} - {C}_{t} ) * V}{1000 * M} \qquad ( Equation 1 )$$

where:
C₀ (mg/L) Initial PNT concentration,
Cₜ (mg/L) PNT concentration at time t,
V (L) Volume of PNT stock solution, and
M (g) Mass of adsorbent.
   A pseudo second order model was used to fit the kinetics data across the three carbon nanomaterial networks. The linearized Lagergren second-order kinetic equation may be represented as:

$$\frac{t}{{q}_{t}} = \frac{1}{{k}_{2} {q}_{e}^{2}} + \frac{1}{{q}_{e}} t \qquad ( Equation 2 )$$

where:
k2 (in g/mg/hour) is the pseudo-second-order rate constant, and
t is time in hours.
qₜ (mg/g) amount of PNT adsorbed onto an adsorbent at time t
qₑ (mg/g) amount of PNT adsorbed onto adsorbent at pseudo-equilibrium

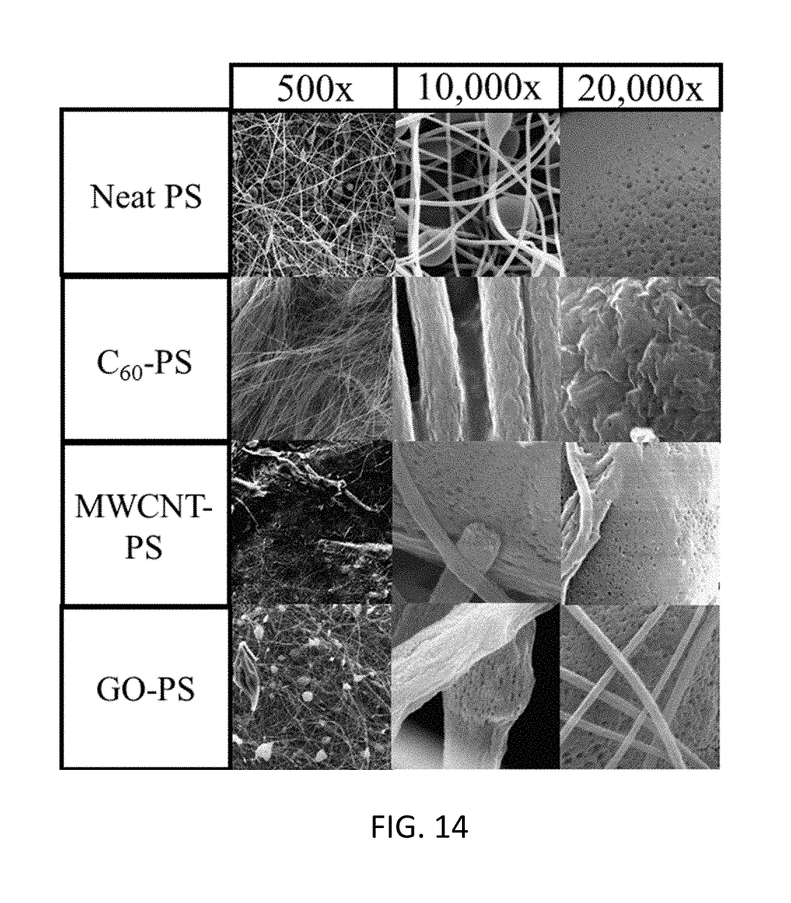

Comparison of Fiber Morphologies Hybridized with 0D, 1D, and 2D Carbon Nanomaterials. Electrospun fibers with different types of CNMs were synthesized to test the hypothesis that the porous nature of hybrid CNM composites would lead to increases in diameter, pore size, and number of pores compared to a neat PS fiber. FIG. 14 shows SEM images of electrospun PS fibers neat and hybridized with C₆₀, MWCNT, and GO NMs. Common morphological changes due to CNM addition include wrinkled, rough fiber surfaces, beads, broken fibers, and adhered parallel fibers. The left column of images in FIG. 14 shows the macroscale structures of the four fiber types, and the middle and rightmost columns show the surface morphologies at increasing magnification. Beads (visible in left and middle columns and marked by white asterisks in image) are a common occurrence in electrospun fibers because increases in viscosity of the electrospinning solution prevent stretching into fiber segments. The C₆₀-PS composite fiber showed long, continuous segments with no visible beads at macroscale. The MWCNT-PS composite fiber showed some beading. GO-PS and neat PS showed relatively higher bead frequency. Increased magnification on the polymer beads and fiber segments in the rightmost column began to reveal pores on the fiber surface (i.e., surface pores, as opposed to pores formed by overlapping fiber strands). The beads and fiber segments in all samples had rough and porous surfaces. These images indicated a possible internal porosity of CNM-PS composite fibers.

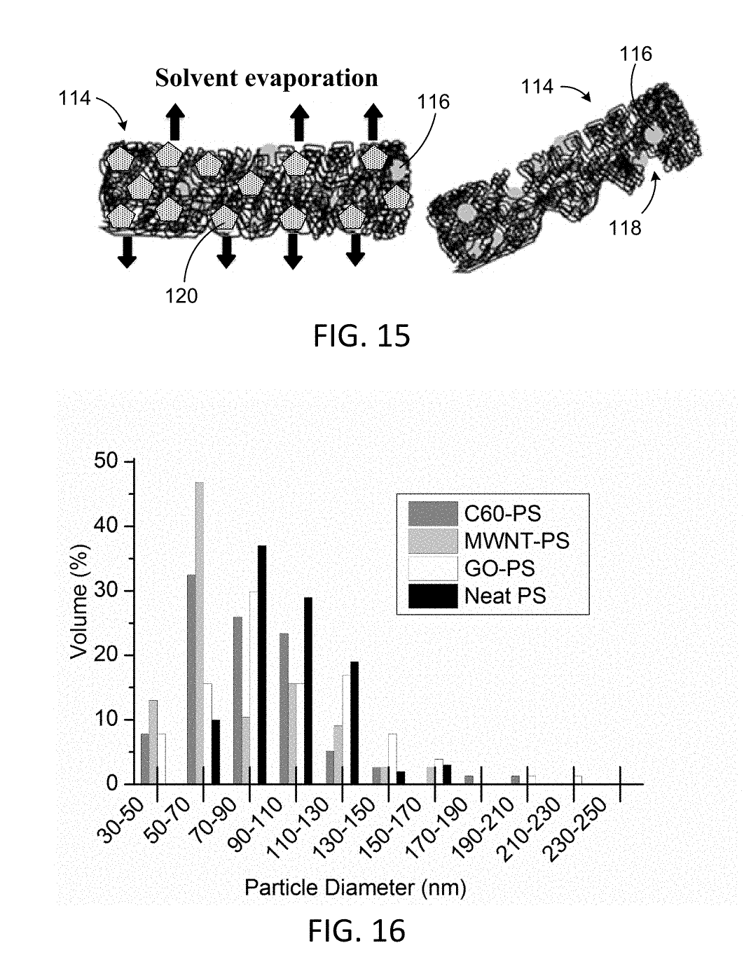

Formation of pores in a nanocomposite fiber is depicted in FIG. 15. In one example of porous nanocomposite fiber formation, a mixture of nanomaterial (e.g., carbon nanomaterial) and solvent (e.g., DMF) are sonicated. Polymer (e.g., PS) is combined with the nanomaterial and solvent mixture to yield a polymer solution. The polymer solution is typically stirred for a length of time (e.g., overnight). A composite fiber is produced by electrospinning. FIG. 15 depicts solvent molecules 120 sorbed to nanomaterial 116 in polymer fiber 114. Solvent molecules 120 volatilize in the electric field, leaving behind pores 118 in polymer fiber 114 as the solvent molecules separate from the polymer coating. Pores 118 may serve as access points for pollutants in water and the encapsulated sorptive nanomaterial inside the polymer fiber. In one example, after volatilization of solvent molecules 120, polymer fiber 114 contains 4 wt % nanomaterial. In some cases, a shallow surface porosity is produced by the imprints of water vapor volatizing into the air.

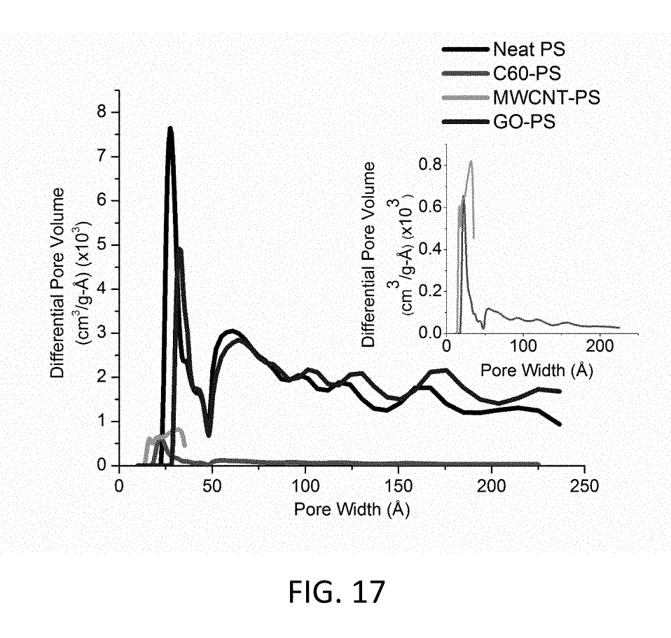

The pore size distribution in FIG. 16, quantified with SEM images of FIG. 14, shows little effect on pore size between neat PS, C₆₀-PS, MWCNT-PS, and GO-PS fibers. The C₆₀-PS network pores averaged 80±30 nm, the MWCNT-PS network pores averaged 120±30 nm, the GO-PS network pores averaged 140±40 nm, and the neat PS network pores averaged 100±20 nm. Due to the resolution limits of the SEM instrument, the surface pore diameter analysis utilized in FIG. 16 is generally limited to macropores (>25 nm/1,000 Å). Nitrogen adsorption-desorption isotherms were performed to obtain additional information about the pore structure within the fiber at the meso- and micropore scale (mesoporous 100-1,000 Å, microporous <100 Å). The pore size distributions for neat PS, C₆₀-PS, MWCNT-PS, and GO-PS given in FIG. 17 were calculated using the Kelvin equation approximating each pore as cylindrical and using the Halsey film thickness approximation. The neat PS and the GO-PS had pores of similar sizes. Neat PS had pores distributed tightly around 25 Å and higher distributions between 50 and 250 Å. The GO-PS distributions are shifted on the x-axis, toward slightly larger pores with the largest at approximately 30 Å, and also showed distributions between 50 and 250 Å. The C₆₀-PS fiber had a small peak at 34 Å and a higher distribution of pores from 35 to 100 Å. MWCNT-PS fiber pore volumes had no sharp peaks and were within 10 to 55 Å; no pores larger than 55 Å were detected.

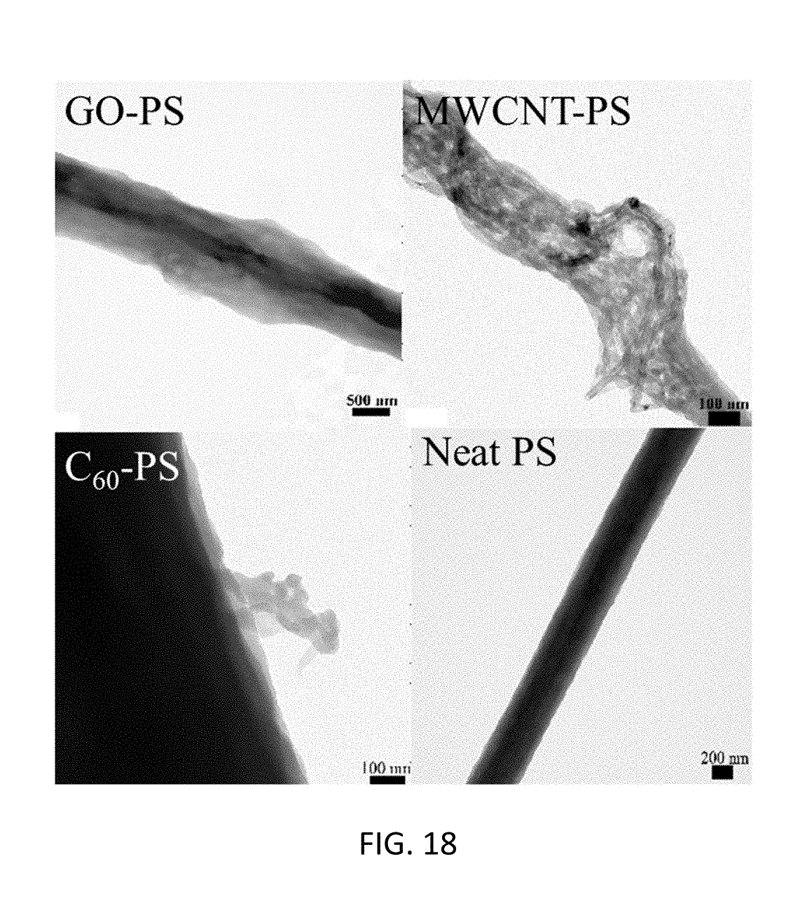

TEM micrographs of carbon nanomaterial PS composite fibers are shown in FIG. 18. The carbon nanomaterials are visible inside the polymer fibers along the entire fiber length visible in the TEM image. The graphene oxide inside the fiber can be identified by its flaky appearance, particularly visible near the surface of the fiber segment. Graphene oxide is known to localize in the surface regions of electrospun polymer fibers due to rapid solvent evaporation. The MWCNT can be seen as tangled threads inside and outside of the main fiber segment. The C₆₀ fiber segment shown in the last row is very dense and opaque; however, C₆₀ can be distinguished by the flaky edge of the fiber segment.

Table 2 summarizes fiber diameters of carbon nanomaterial PS network fibers ranging from about 400 to 1700 nm. C₆₀-PS and GO-PS networks had the largest diameters, 1700±870 nm and 1700±840 nm, respectively. The MWCNT-PS fibers had a diameter of 650±190 nm, and the neat PS had the smallest diameter, 410±390 nm. Diameters of electrospun fibers can vary with process parameters such as viscosity and conductivity of solution and increases in voltage needed to successfully form a charged jet. The addition of nanomaterials increases the viscosity of electrospinning solutions; generally, more viscous solutions will produce fibers with higher diameters. This condition can be overcome by increasing the conductivity of the solution, facilitating the formation and maintenance of a charged jet of electrospinning solution between the needle tip and the collector plate. The presence of the MWCNT in the polymer solution increased the charge-carrying capacity of the solution, therefore facilitating further jet stretching resulting in smaller diameter fibers. The neat PS fiber diameters are the smallest due to the absence of any viscosity-increasing nanomaterial addition. For batch adsorption, fiber diameter is not particularly important, as water is not flowing through the fibers. Table 2 lists BET surface areas described in FIG. 17 for comparison. Wettability measurements in Table 2 show that all fibers are hydrophobic.

TABLE 2
Fiber and particle diameters, BET surface area, adsorption capacity, and rate constant
for carbon nanomaterials and carbon nanomaterial PS fibers.

| | Fiber/Particle | BET Surface | Water |
|---|---|---|---|
| Material | Diameter (nm) | Area (m²/g) | Contact Angle |
| Neat PS | 410 ± 390* | 91 | 110 ± 7 |
| C₆₀-PS | 1700 ± 870* | 6 | 103 ± 3 |
| C₆₀ | 0.7 | n/a (unstable) | — |
| MWCNT-PS | 650 ± 190* | 16 | 105 ± 8 |
| MWCNT | 15^{a} | 140 | — |
| GO-PS | 1700 ± 840* | 73 | 116 ± 2 |
| Graphene oxide | 2-3 thick, | 91 | — |
| | 7000 long^{a} | | |

* = measured via ImageJ (n = 500 measurements) from SEM images
^{a} = from manufacturer

These fibers were produced using a successive electrospinning and electrospraying of 1% (m/v) carbon nanomaterial fiber. In order to approximate what mass of carbon nanomaterial was present in the final fibers, Programmable Thermal Analysis (PTA) was used for GO-PS and MWCNT-PS fibers. Based on multiple measurements of the same fiber, PTA detected carbonaceous NMs in the fibers at 3±1% (m/v) for GO and at 8±1% (m/v) for MWCNT. C₆₀-PS proved too thermally unstable to use PTA, so a method was used where C₆₀-PS composites were dissolved in toluene, and their C₆₀ content was measured using UV-visible spectroscopy. After taking various measurements, it was determined that the C₆₀ content of these fibers was 4±0.3% (m/v). Although CNM mass composition varied slightly, all fibers were found to contain CNM.

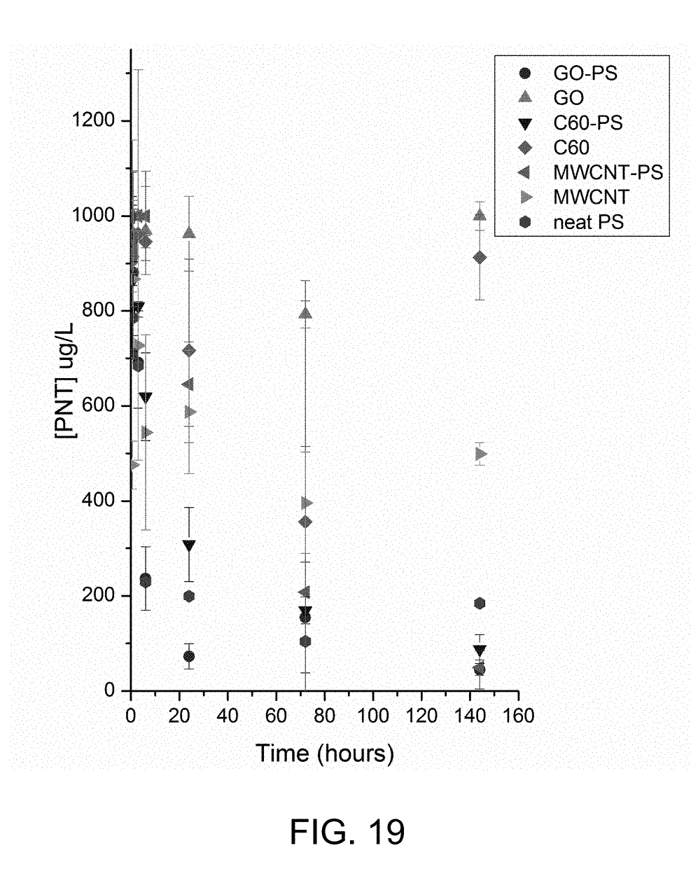

Viability of Carbon Nanomaterial PS Composite Fiber Morphologies by PNT Adsorption. FIG. 19 shows adsorption kinetics of PNT by GO-PS, C₆₀-PS, MWCNT-PS and neat PS. In control sample (no carbon nanomaterials or carbon nanomaterial PS composites) PNT concentrations were unchanged over time, showing there was negligible PNT loss from reactors. The neat PS fiber reached pseudo-equilibrium in one day and removed over 90% of PNT from solution. Neat PS fibers adsorb hydrocarbons onto their hydrophobic, porous surface. Despite variations in fiber morphology, the carbon nanomaterial PS composite fibers exhibited similar PNT removal profiles as the neat PS fiber.

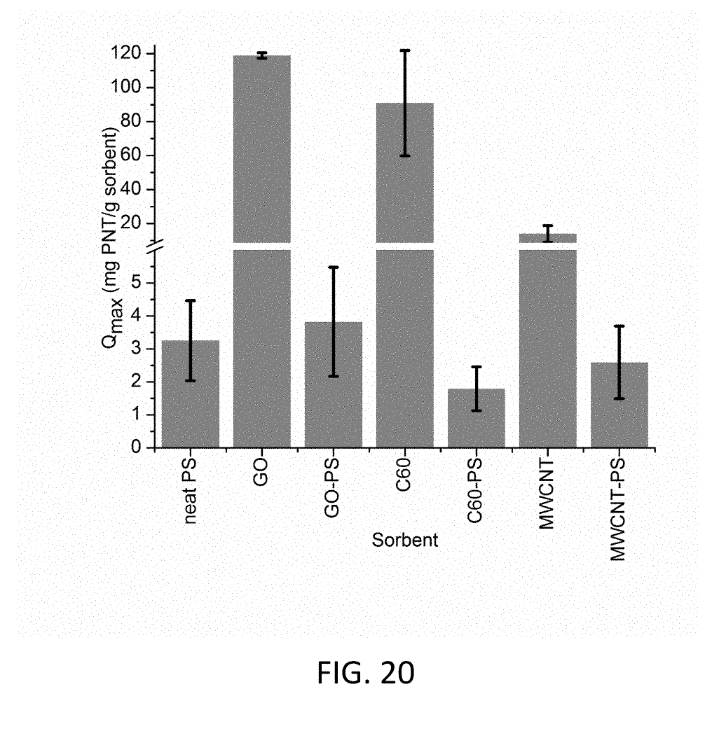

GO-PS, MWCNT-PS, C₆₀-PS, and neat PS fibers all reached pseudo-equilibrium after about 24 hours. The adsorption capacities at pseudo-equilibrium (after 6 days, qₑ) were calculated using Equation 1. Adsorption capacities at pseudo-equilibrium (qₑ) are summarized in Table 2 and FIG. 20. GO-PS, neat PS, MWCNT-PS, and C₆₀-PS reached adsorption capacities: 3.9, 2.9, 2.6, and 1.8 mg/g, respectively. Graphene-oxide-PS and neat-PS have higher (p<0.05 according to Student's t-test) sorption capacities than MWCNT-PS and C₆₀-PS. The BET surface area measurements (Table 2) also showed that neat PS and GO-PS have higher specific surface areas. Similarities in adsorption performance of PS, C₆₀-PS, MWCNT-PS, and GO-PS coupled with the hydrophobic character of PS-based fibers (see Table 2 for wettability data) suggests that PNT removal by carbon nanomaterial PS fibers is a product of the hydrophobic effect. All four fibers had a contact angle greater than 90° (Table 2) and were thus hydrophobic. Contact angle testing illuminates the interaction between the fiber, PNT, and water molecules within a batch system. When the PNT and PS are in proximity, entropy within the water-fiber-PNT system increases as the water molecules surrounding both the nonpolar molecules release. This makes the PS-PNT association thermodynamically favorable and forms a nonpolar aggregate that leads to the extraction of PNT from the aqueous matrix along with the PS.

In parallel, kinetic adsorption data was generated for suspended CNM (i.e., without PS fibers) in water (see FIG. 19). The order of adsorption capacity for each material after 144 hours was graphene oxide>MWCNT=C₆₀ (results were statistically verified using Student's t-test, p<0.05).

In summary, carbon nanomaterials of three different dimensions (0D, 1D, 2D) were incorporated into polymer fibers via electrospinning to evaluate the effect of nanomaterial dimensionality on fiber diameter, pore size, and pore frequency compared to neat polymer fiber. Beads and pores were found across all three nanomaterial composites, and pore size stayed consistent across all fibers. Addition of carbon nanomaterial to PS had a notable effect on fiber diameter, as carbon nanomaterial fiber diameters increased upon addition of the nanomaterial to the polymer. Wettability measurements showed that all fibers are hydrophobic. GO-PS and PS fibers showed comparable adsorption capacity (3.8 mg/g and 2.9 mg/g, respectively). MWCNT-PS, reached a removal capacity of 2.6 mg/g, and C₆₀-PS reached a capacity of 1.8 mg/g; all materials reached pseudo equilibrium after 24 hours. Removal of PNT by PS fibers is believed to be due at least in part to the hydrophobic effect. Overall, these three materials were easily dispersed and spun into carbon nanomaterial networks. Thus, electrospinning presents an economical and facile method of incorporating carbon nanomaterial into thin polymer-supported networks, allowing for the exploitation of favorable properties and low volume of the carbon nanomaterials, while inhibiting loss of carbon nanomaterials to aqueous environments in which they are used.

A number of embodiments have been described. Nevertheless, it will be understood that various modifications may be made without departing from the spirit and scope of the disclosure. Accordingly, other embodiments are within the scope of the following claims.

What is claimed is:

1. A method of fabricating nanocomposite fibers, the method comprising electrospinning a solution comprising a polymer, a solvent, and a nanomaterial to yield porous nanocomposite fibers.

2. The method of claim 1, wherein a diameter of the nanocomposite fibers is in a range of 0.5 μm to 5 μm.

3. The method of claim 1, wherein the porous nanocomposite fibers define pores having a pore size in a range of 25 nm to 200 nm.

4. The method of claim 1, wherein the polymer comprises polystyrene, polyvinylpyrrolidone, polyvinyl alcohol, polyacrylonitrile, polyvinylidine fluoride, or polycaprolactone.

5. The method of claim 1, wherein the nanomaterial comprises at least one of a metal, a metal oxide, or a carbonaceous nanomaterial.

6. The method of claim 5, wherein the nanomaterial comprises Ag, Cu, or Zn.

7. The method of claim 5, wherein the nanomaterial comprises TiO₂, In₂O₃, or Fe₂O₃.

8. The method of claim 5, wherein the nanomaterial comprises graphene, graphene oxide, carbon nanotubes, or activated carbon.

9. A nanocomposite fiber comprising a nanomaterial embedded in a porous polymer fiber.

10. The nanocomposite fiber of claim 9, wherein the polymer fiber comprises polystyrene, polyvinylpyrrolidone, polyvinyl alcohol, polyacrylonitrile, polyvinylidine fluoride, or polycaprolactone.

11. The nanocomposite fiber of claim 9, wherein the nanomaterial comprises at least one of a metal, a metal oxide, or a carbonaceous nanomaterial.

12. The nanocomposite fiber of claim 11, wherein the nanomaterial comprises Ag, Cu, or Zn.

13. The nanocomposite fiber of claim 11, wherein the nanomaterial comprises TiO₂, In₂O₃, or Fe₂O₃.

14. The nanocomposite fiber of claim 11, wherein the carbonaceous nanomaterial comprises graphene, graphene oxide, carbon nanotubes, or activated carbon.

15. The nanocomposite fiber of claim 14, wherein the carbonaceous nanomaterial comprises carbon nanotubes, and the carbon nanotubes are aligned longitudinally in the nanocomposite fiber.

16. The nanocomposite fiber of claim 9, wherein the nanomaterial comprises 0.1 wt % to 10 wt % of the nanocomposite fiber.

17. A material comprising a plurality of nanocomposite fibers, each nanocomposite fiber comprising a nanomaterial embedded in a porous polymer fiber.

18. The material of claim 17, wherein the polymer fiber comprises polystyrene, polyvinylpyrrolidone, polyvinyl alcohol, polyacrylonitrile, polyvinylidine fluoride, or polycaprolactone.

19. The material of claim 17, wherein the nanomaterial comprises at least one of a metal, a metal oxide, or a carbonaceous nanomaterial.

20. The material of claim 17, wherein the material is in the form of a non-woven fabric.
